(19) United States
(12) Patent Application Publication
(10) Pub. No.: US 2005/0273612 A1
(43) Pub. Date: Dec. 8, 2005

(54) Identification of digital data sequences

(75) Inventors: Minne Van Der Veen, Eindhoven (NL); Alphons Antonius Maria Lambertus Bruekers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/521,848

(22) PCT Filed: Jun. 26, 2003
(86) PCT No.: PCT/IB03/02812

§ 371 Date: Jan. 21, 2005

(30) Foreign Application Priority Data
Jul. 26, 2002 (EP) 02078079.7

(51) Int. Cl. H04L 9/00

(52) U.S. Cl. 713/176

(57) ABSTRACT

Identification of a digital media sequence is performed by an encoding and a decoding process. A sequence is received and its digital fingerprint is computed. A database lookup based on the fingerprint produces one or more matches that all resemble the computed fingerprint to a certain degree. If there is more than one match, at least one attempt is made to detect a watermark in the sequence. If a watermark is found, at least part of the watermark is extracted and used to select one of the matches among the sequences that resemble the media sequence to be identified.

The invention relates to a method and a system for enabling identification of a digital data sequence.

The handling of media content such as audio, images and image sequences have during the last decade or two entered the “digital era”. More and more of the media content that is produced is produced, stored and transmitted via digital means such as computer storage media and digital transmission networks. Needless to say, this has lead to advantages as well as problems; in particular problems relating to legal issues such as proof of ownership of the media content and the problem of unauthorized copying of the content.

Prior art includes at least two techniques to identify digital media content. These are watermarking and fingerprinting.

The watermarking technique can be summarized in that a unique identifier, i.e. a digital sequence of bits, is imperceptibly hidden in the content and can be extracted by a receiver for further processing, such as identification and authorization. However, a problem with the watermarking technique is that a large amount of bits needs to be embedded to allow globally unique identification, but it is very difficult to hide such a large identifier whilst making it impossible or very difficult to remove it from the media sequence in which it is embedded.

The fingerprinting technique involves recognizing unique features of a digital media sequence representing the content and converting these into a, ideally unique, bit sequence, i.e. a fingerprint. This fingerprint can be compared with other fingerprints and thereby identify the content in relation to other media sequences. However, a problem with fingerprinting is that a particular fingerprint might match two or more fingerprints of media sequences. This problem is further accentuated when the fingerprinting technique involves ignoring “unreliable” bits in the fingerprint, i.e. when a certain level of robustness with respect to noise etc is needed.

In prior art, such as disclosed in UK patent application published with number 2 361 136, the watermarking and fingerprinting techniques have been combined in order to improve identification of digital audio/video streams. In order to improve the procedure of proving provenance of a digital data stream, an identifying code in the form of a watermark is inserted into the data and a signature is also calculated based on the data. The watermark and the signature hence provides two independent means of proving provenance.

The object of the present invention is to provide a solution to the problem of how to simplify identification of digital media sequences.

The object is achieved according to two aspects by way of methods systems and computer programs according to the appended claims.

In some detail, there is provided according to a first aspect of the invention, a method, a system and a computer program for identifying a first digital data sequence. The method comprises calculating a first digital fingerprint based on at least part of the first sequence. This fingerprint is then compared with at least a second fingerprint, which is associated with at least another, second digital data sequence. Depending on a result of the comparison, at least one digital watermark associated with the respective first and second data sequences is compared and, resulting from the comparison it is thereby possible to establish an identity of the first data sequence.

According to a second aspect of the invention there is provided a method, a system and a computer program for enabling identification of a first digital data sequence. The method comprises calculating a first digital fingerprint based on at least part of the first sequence. This fingerprint is then compared with at least a second fingerprint, which is associated with at least another, second digital data sequence. Depending on a result of the comparison, the watermark associated with the first sequence is stored for further use in enabling the identification of the data sequence.

Moreover, the use of the watermark may involve using watermark information that is calculated in dependence of the information contained in the first fingerprint or the difference between the fingerprint and fingerprints already stored in the database.

The technical effect obtained by the invention is hence that of enabling identification of a data sequence by a conditional combination of watermarking and finger-printing, which can be seen as a hybrid identification method and system or, as the two aspects of the invention illustrate, in an encoding aspect and a decoding aspect.

When a content item, i.e. a digital sequence representing a media item or a part of a media item, is received for identification, a fingerprint is computed and added to a database, preferably also together with appropriate metadata. The newly calculated fingerprint is compared with fingerprints that already exist in the database. If it is found that there is a sufficiently small distance between the newly computed fingerprint and an existing fingerprint, a watermark is embedded in the content of the data sequence. This watermark preferably contains additional identifying information. This identifying information is then preferably also added as metadata to the database entry for that content item.

Identification of the media sequence can then proceed as follows. A sequence that is to be identified is received and its fingerprint is computed. A database lookup based on the fingerprint produces one or more matches that all resemble the computed fingerprint to a certain degree. If there is more than one match, at least one attempt is made to detect a watermark in the sequence. If a watermark is found, at least part of the watermark is extracted and used to select one of the matches among the sequences that resemble the media sequence to be identified.

The watermark, or a part thereof, is then an identifier of the media sequence. The identifier preferably represents the content item itself, but can also represent, e.g., the content owner for broadcast monitoring or otherwise provide an association between the media sequence and its provider or owner etc.

In fact, the invention may be divided into three separate sub-processes: an embedding process, an data base storage process and a detection (i.e. identification) process. During the embedding process, the database is generated as described containing fingerprints and watermarks. One or more of the parameters that are contained in the information of the watermark is, in whole or in part, determined by the results from a comparison operation in which a fingerprint is compared with existing fingerprints in the database. In the database storage process, information of the watermark is appended. Example of such information is type of watermark, watermark key, payload, etc. The storing of information in the database can be considered as a “training” process, in the sense that the information in the database will be more and more of use during later consultations of the database during future detection/identification processes.

The detection process is most simply described as an identification process where a digital signal is identified using the database of fingerprints and metadata as well as the watermarks.

An advantage of the invention is that only a part of all considered content items need to be provided with a watermark. Only if there is a risk of a “clash” between two entries in the database, i.e. if there is a risk of confusing the media sequence with other media sequences. This means that the total number of watermarked content items is lower than in a pure watermark-based identification system. As a result, the identifier in the form of a watermark to be embedded can be smaller, when compared with prior art, because it needs only be unique amongst the small number of content items that are watermarked. This reduces the required capacity of the watermark.

The invention will now be described by way of preferred embodiments, with reference to a number of figures, where:

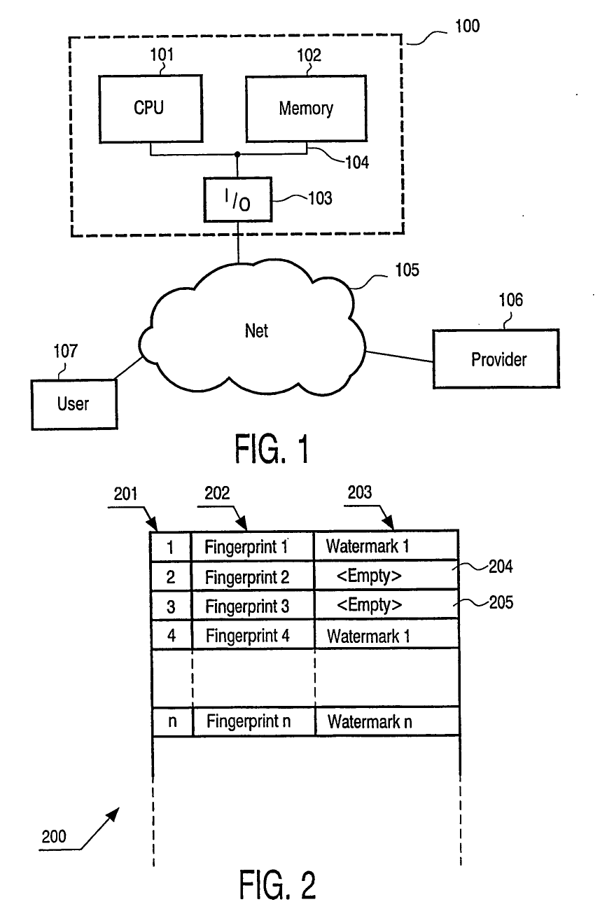

FIG. 1 shows schematically a system according to the invention;

FIG. 2 shows schematically a database structure in accordance with the invention; and

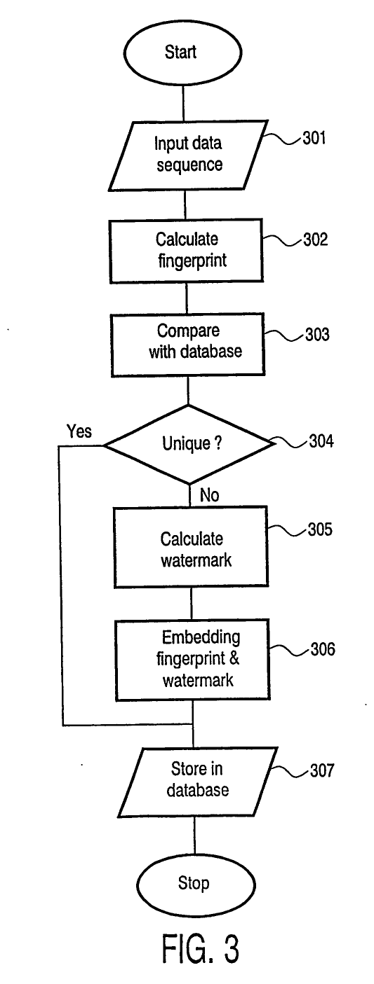

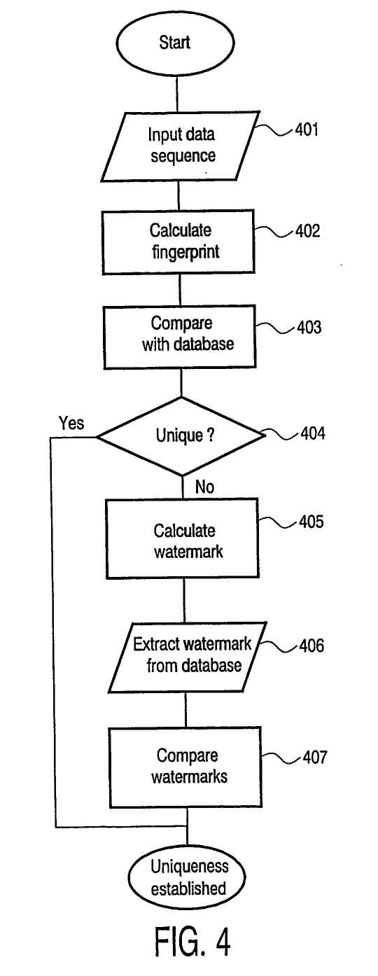

FIGS. 3 and 4 show a flow chart of a method according to the invention.

A method and a system which combines watermarking and fingerprint technology will now be described in some detail. As the person skilled in the art will recognize, the method and the system both involve processing means and memory units as well as communication means that are of a general character of of a more specialized character. That is, general purpose computers with peripheral units such as hard disks, CD/DVD-recorders and connected to a digital network such as the internet may be utilized in an implementation of the invention. Specifically designed systems, comprising processors, memory units and communication means that are capable of only implementing the present invention are also feasible and are feasible to the person skilled din the art of designing hardware and software in computing systems.

FIG. 1 shows a schematic hardware view of a computing system 100 comprising a processor 101, a memory unit 102 and an input/output unit 103 that are interconnected via a bus 104. The system 100 is in connection with a digital communication network 105 through which information in the form of, e.g. digital media sequences including audio, video or any other sequence that the system 100, a provider 106 and a user 107 wish to communicate. As the person skilled in the art will realize, the system 100 may include a number of additional units.

Turning now to a discussion of a method according to the invention, where a digital media sequence is to be handled by the system, the initial state of the system 100 will be defined.

Referring first to FIG. 2, illustrates a previously established database 200, which preferably is realized in the memory unit 102 of the system 100. The database 200 comprises information in the form of fingerprints 202 of digital media sequences as referenced by sequential numbers 201. The fingerprints 202 in the database 200 are, as the skilled person realizes a sequence of digits that have been calculated on the basis of the content of the respective media sequence. Linked to the fingerprints 202 are respective watermarks 203. However, not all fingerprints 202 have associated watermarks 203, as indicated by empty watermark positions 204 and 205, which illustrates the advantage of the invention, as presented above, that only part of all considered media sequences need to be provided with a watermark. Additional information, i.e. media content “metadata”, associated with the respective media sequence, can also be accommodated in the database 200.

Continuing with the discussion regarding a method according to the invention, references will now be made to both FIGS. 1, 2 and 3. FIG. 3 shows a flow chart comprising steps performed by the system 100.

In an input step 301, a digital media sequence is input from the media sequence provider 106. In a following calculation step 302, a fingerprint is calculated. The calculated fingerprint, denoted by H_{X}, is in a comparison step 303 compared with fingerprints already present in the database 200, denoted by H_{1 . . . N} where 1 . . . N denote fingerprints numbering between 1 and N.

In a decision step 304, it is decided, if the mathematical distance between the calculated fingerprint H_{X} and the existing ones H₁ . . . N is sufficiently large, i.e. if M(H_{X},H_{1 . . . N})>D₁, where M defines a mathematical distance measure and D₁ is a limiting distance, then the fingerprint is defined as being unique. Then the process continues with a storage step 307 where the fingerprint is stored in the database and associated with the media sequence. That is, in the case of uniqueness of the fingerprint, recognition based on only fingerprints is be successful.

However, if a possible non-uniqueness occurs, i.e. if M(H_{X},H_{1 . . . N})<D₁, a watermark W_{X} is calculated in a calculation step 305 and embedded in the media sequence X in an embedding step 306. This watermark may contain additional identification information based on results obtained during the comparison step 303, i.e. a set of watermarks, which were used in the embedding of the corresponding multi-media signals. Based on this set of watermarks, a new watermark is chosen. For example by choosing a new key or new payload for the watermark. This is then used for embedding in the new multimedia signal.

As for the case where the uniqueness was decided, in the decision step 304, the new fingerprint and associated watermark are appended to the database 200.

In an identification process, which may be performed by the user 107 when asking the system 100 for identification of a media sequence, the following steps may be performed by the system, as illustrated in the flow chart of FIG. 4.

In an input step 401, a digital media sequence is input to the system 100. In a following calculation step 402, a fingerprint is calculated. The calculated fingerprint, denoted by H_{X}, is in a comparison step 403 compared with fingerprints already present in the database 200, denoted by H_{1 . . . N} where 1 . . . N denote fingerprints numbering between 1 and N.

In a decision step 404, it is decided, if the mathematical distance between the calculated fingerprint H_{X} and the existing ones H_{1 . . . N} is sufficiently large, i.e. if M(H_{X},H_{1 . . . N})>D₂, where M defines a mathematical distance measure and D₂ is a limiting distance, then the uniqueness of the fingerprint has been established, i.e. the identity recognition has been based on fingerprints only.

However, if a possible non-uniqueness occurs, i.e. if M(H_{X},H_{1 . . . N})<D₂, a watermark W_{X} is calculated in a calculation step 405. Watermarks 203 in the database 200 that are associated with the fingerprints 202 that were found to be mathematically close to the fingerprint of the media sequence are then extracted from the database 200 in an extraction step 406. Finally, the calculated watermark is compared, in a comparison step 407, with these extracted watermarks and thereby establishing the uniqueness of the media sequence.

It is to be noted that, although the embodiments above discuss sequences of media data in a very general manner, it is understood that any type of media is relevant, and can be exemplified by digital audio or video sequences as well as other sequences of data that is to be identified and/or associated with, e.g., an owner or provider. Any such sequence is considered to be equivalents and are within the scope of the appended claims.

Hence, to summarize, identification of a digital media sequence is performed by an encoding and a decoding process. A sequence is received and its digital fingerprint is computed. A database lookup based on the fingerprint produces one or more matches that all resemble the computed fingerprint to a certain degree. If there is more than one match, at least one attempt is made to detect a watermark in the sequence. If a watermark is found, at least part of the watermark is extracted and used to select one of the matches among the sequences that resemble the media sequence to be identified.

1. A method for identifying a first digital data sequence, comprising:
calculating a first digital fingerprint based on at least part of the first sequence,
comparing the first fingerprint with at least a second fingerprint associated with at least a second digital data sequence,
depending on a result of the comparison, comparing at least one digital watermark associated with the respective first and second data sequences and thereby establishing an identity of the first data sequence.

2. A method according to claim 1, further comprising:
calculating the at least one digital watermark, where the calculation is dependent on information contained in the first fingerprint.

3. A method according to claim 1, further comprising:
calculating the at least one digital watermark, where the calculation is dependent on information resulting from the comparison between the first fingerprint and the second fingerprint.

4. A system for identifying a first digital data sequence, comprising means for:
calculating a first digital fingerprint based on at least part of the first sequence,
comparing the first fingerprint with at least a second fingerprint associated with at least a second digital data sequence,
depending on a result of the comparison, comparing at least one digital watermark associated with the respective first and second data sequences and thereby establishing an identity of the first data sequence.

5. A system according to claim 4, further comprising means for:
calculating the at least one digital watermark, where the calculation is dependent on information contained in the first fingerprint.

6. A system according to claim 4, further comprising means for:
calculating the at least one digital watermark, where the calculation is dependent on information resulting from the comparison between the first fingerprint and the second fingerprint.

7. A computer program including software instructions for controlling a computer to perform a method according to claim 1.

8. A method for enabling identification of a first digital data sequence, comprising:
calculating a first digital fingerprint based on at least part of the first sequence,
comparing the first fingerprint with at least a second fingerprint associated with at least a second digital data sequence,
depending on a result of the comparison, storing at least one digital watermark associated with the first data sequence, thereby providing information enabling identification of the first data sequence.

9. A method according to claim 8, further comprising:
calculating the at least one digital watermark, where the calculation is dependent on information contained in the first fingerprint.

10. A method according to claim 8, further comprising:
calculating the at least one digital watermark, where the calculation is dependent on information resulting from the comparison between the first fingerprint and the second fingerprint.

11. A system for enabling identification of a first digital data sequence, comprising means for:
calculating a first digital fingerprint based on at least part of the first sequence,
comparing the first fingerprint with at least a second fingerprint associated with at least a second digital data sequence,
depending on a result of the comparison, storing at least one digital watermark associated with the first data sequence, thereby providing information enabling identification of the first data sequence.

12. A system according to claim 11, further comprising means for:
calculating the at least one digital watermark, where the calculation is dependent on information contained in the first fingerprint.

13. A system according to claim 11, further comprising means for:
calculating the at least one digital watermark, where the calculation is dependent on information resulting from the comparison between the first fingerprint and the second fingerprint.

14. A computer program including software instructions for controlling a computer to perform a method according to claim 8.
